(19) United States
(12) Patent Application Publication
(10) Pub. No.: US 2019/0241298 A1
(43) Pub. Date: Aug. 8, 2019

(54) BAGGING SYSTEM FOR STORE MERCHANDISE

(71) Applicant: Walmart Apollo, LLC, Bentonville, AR (US)

(72) Inventors: Cristy Crane Brooks, Cassville, MO (US); Benjamin D. Enssle, Bella Vista, AR (US); David Blair Brightwell, Bentonville, AR (US); Jesse Lee Eaton, Springdale, AR (US); Jeffrey A. Kerbs, Bentonville, AR (US); Greg A. Bryan, Centerton, AR (US)

(21) Appl. No.: 16/266,433

(22) Filed: Feb. 4, 2019

Related U.S. Application Data
(60) Provisional application No. 62/626,470, filed on Feb. 5, 2018.

(51) Int. Cl. B65B 57/10; B65B 5/10; B65B 67/12; B25J 9/16; A47F 9/04

(52) U.S. Cl. CPC B65B 57/10; B65B 5/105; B65B 67/1227; B65B 2067/1294; B25J 9/1679; A47F 9/043; A47F 9/048; B25J 9/1694

(57) ABSTRACT

A bagging station, comprises a base; a carousel that rotates relative to the base, the carousel including a plurality of bag holding elements; an indicator at each bag holding element that provides a status regarding a bag hanging from the bag holding element; and a bag selection system that controls the indicators to identify bags for allocating items according to a predetermined criteria about at least one of the bag or the items.

### RELATED APPLICATIONS

This application claims the benefit of U.S. Provisional Patent Application No. 62/626,470 filed Feb. 5, 2018 and entitled “Bagging System for Store Merchandise,” the contents of which are incorporated by reference herein in their entirety.

### FIELD OF THE DISCLOSURE

The present disclosure relates generally to retail store bagging systems, and more specifically, to a bagging station that systematically manages the input of retail store items into bags according to a predetermined compliance with respect to parameters established for the bags.

### BACKGROUND

Conventional store checkout counters typically include a conveyor belt where shoppers can place items for purchase, which are transported to a point of sale (POS) machine where a store clerk, or the shopper at a self-checkout counter, may scan the items for identification and price and purchase the items. After the items are scanned, they are placed into shopping bags by the customer or store clerk. In some stores, a bagging carousel or other apparatus on which the bags are hung may be positioned at the end of the counter, where the store clerk or shopper inserts the items on the conveyor belt into a bag until it is sufficiently filled. The filled bags may then be removed from the hangers and placed into the shopper's cart or carried away from the store by hand.

### SUMMARY

In one aspect, a bagging station comprises a base and a carousel that rotates relative to the base, the carousel including a plurality of bag holding elements; an indicator at each bag holding element that provides a status regarding a bag hanging from the bag holding element; and a bag selection system that controls the indicators to identify bags for allocating items according to a predetermined criteria about at least one of the bag or the items.

In another aspect, a bagging station comprises a base; a carousel that rotates relative to the base, the carousel including a plurality of bag holding elements; an indicator at each bag holding element that provides a status regarding a bag hanging from the bag holding element; a bag selection system that controls the indicators to identify bags for allocating items according to a predetermined criteria about at least one of the bag or the items; a robotic arm extending from the carousel and having an end effector for gripping the bags for at least one of automatically placing the allocated items into the identified bags or moving the bags including the allocated items from the carousel to a different location; and a controller that directs the robotic arm to at least one of insert the items into the identified bags according to the predetermined criteria or move the bags including the allocated items from the carousel to the different location.

In another aspect, a bagging station comprises a base and a carousel that rotates relative to the base, the carousel including a plurality of bag holding elements; a robotic arm extending from the carousel and having an end effector for at least one of automatically placing items into bags on the bag holding elements or removing the items from the bags from the bag holding elements; a visual indicator at each bag holding element that provides a status regarding the bag hanging from the bag holding element; and a controller that directs the robotic arm to move the items or shopping bags according to predetermined criteria.

In another aspect, a machine-readable storage medium has stored therein a computer program for selecting a bag at a bagging station, the computer program comprising a set of programmable instructions for causing the machine to perform the steps of: receiving machine-readable bagging preference data; receiving machine-readable item data; and controlling a bagging carousel to identify a shopping bag from a plurality of bags for receiving an item of merchandise corresponding to the machine-readable item data.

### BRIEF DESCRIPTION OF THE DRAWINGS

Exemplary embodiments will now be described, by way of example only, with reference to the following drawings, in which:

FIG. 1 is a perspective view of a bagging station, in accordance with some embodiments.

FIG. 2 is a perspective view of a bagging station including a robotic arm, in accordance with some embodiments.

FIG. 3 shows an example of a layout of a system including a bagging carousel of FIG. 1 or 2 for performing a retail operation, in accordance with some embodiments.

FIG. 4 is a top view of a bagging carousel of FIGS. 1-3 constructed and arranged for receiving items for bagging according to predetermined categories, in accordance with some embodiments.

FIG. 5 is a view of a system for transferring bags including received items from a bagging station of FIGS. 1-4 to a shopping cart, in accordance with some embodiments.

FIG. 6 is a flow diagram of a method of operating a bagging carousel, in accordance with some embodiments.

FIG. 7 is a block diagram of an autonomous bagging apparatus constructed and arranged to perform mobile operations, in accordance with some embodiments.

### DETAILED DESCRIPTION

Conventional bagging apparatuses are typically constructed and arranged for holding plastic or paper bags, and for positioning a bag in front of a user so that the user can place items into the bag with ease. However, manual effort is required to orient a bag holder so that it is adequately positioned in proximity to the items at the checkout counter for placement into the bags. Moreover, the user determines which items are inserted in to which bags, for example, in configurations where multiple bags are available for the user. A user may be unaware of the capacity of a bag, for example, how much weight a bag may hold before it breaks. The user may be also unaware of or disinterested in item compatibility when placing items in a bag, for example, placing ice cream and hot pizza into the same bag, or placing ammonia and bleach into the same bag, or placing eggs and heavy cans into the same bag.

Described are embodiments of a bagging system that automatically allocate items to shopping bags in accordance with a predetermined bagging compliance, for example, where items of a known compliance or uniform requirement are bagged together, i.e., inserted into a single bag according to indicators provided by the system, or automatically by a robotic arm. These embodiments may further include an automated process for transferring bags of store items to another location of interest, for example, transferring items from a checkout counter to bags according to predetermined criteria, then to a shopping cart, vehicle trunk, or the like, so that a user does not need to touch or move store items throughout the automated checkout of a shopping experience. In some embodiments, the bagging system may be part of a robotic apparatus, unmanned ground or aerial vehicle, or the like, so as to assist a shopper during a shopping experience with retrieving and bagging store items during shopping instead of or in addition to performing such tasks at a checkout.

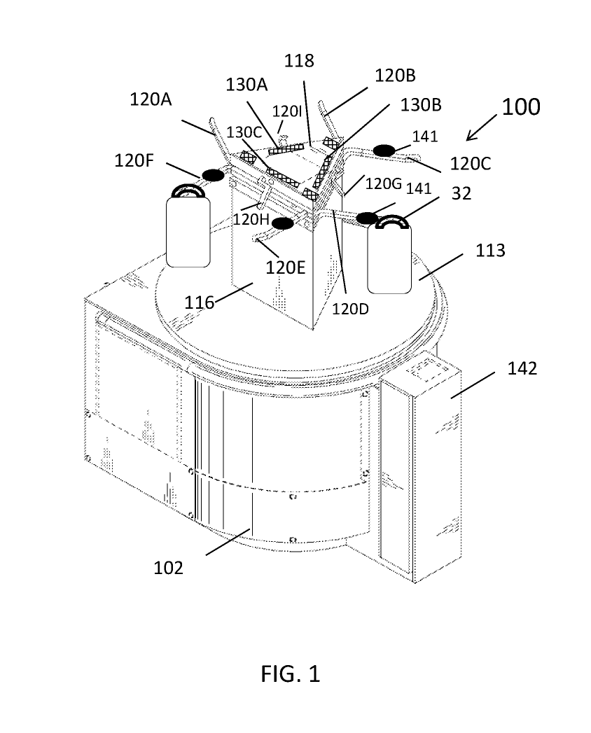

FIG. 1 is a perspective view of a bagging station 100, in accordance with some embodiments. In some embodiments, the bagging station 100 is positioned at a checkout counter occupied by a store clerk or other employee, for example, a store representative who scans the items, collects payment, confirms authenticity of purchase, and so on. In some embodiments, the bagging station 100 is positioned at a self-checkout counter. For example, the bagging station 100 may be positioned at other locations of a self-checkout system, preferably a designated bagging area. In some embodiments, the bagging station 100 may be positioned on, or be part of a vehicle, such as a manned or unmanned ground (AGV) or aerial vehicle (UAV) known to one of ordinary skill in the art, which tracks a user's whereabouts or otherwise is positioned at locations of a store, and can assist the user, for example, a shopper, by performing bagging-related tasks on behalf of the user.

The bagging station 100 may include, but not be limited to, a rotatable carousel top 113, a center piece 116, and a plurality of bag holding elements 120A-120I extending from the center piece 116. The carousel top 113 may be part of a base 102, for example, a stand. Alternatively, the carousel top 113 may be integrated with a region of an operator-attended or self-checkout system, for example, part of a scale, point of sale (POS), conveyor system, and so on. The carousel top 113 functions as a table to hold the center piece 116, and is constructed and arranged to hold one or more shopping bags, while the bag is being filled with store items for purchase. The carousel top 113 can rotate about its axis relative to the base 102. The base 102 may include mechanical components such as an adapter plate, bearings, or the like (not shown) that permit the carousel top 113 to rotate about the top region of the base 102. In doing so, the carousel top 113 may rotate by way of mechanical components such as gears, actuators, motors, and so on which in turn receive control signals or the like from a controller apparatus to perform such rotation functions in accordance with embodiments of the present inventive concepts. A set of wheels (not shown) may be coupled to the bottom of the base 102 to allow the entire bagging station 100 to be moved to other locations.

In some embodiments, center piece 116 has three sides, or a triangular configuration. In some embodiments, center piece 116 has more than three sides, and top surface 118 is a shape other than triangular, such as rectangular, round, oval, or other shape.

The bag holding elements 120A-120I (generally, 120) may include hooks, rods, clamps, spring clips or other extensions or hanging members for holding a shopping bag and its contents. A shopping bag may be paper, plastic, composites, recyclable material, and/or other well-known material or a combination thereof. The elements 120 may include bag upper edge holders that grasp the upper edge of an open bag in order to hold the bag open and in place while items are placed in the bag so the bag can be filled. In the embodiment shown, bagging station 100 includes six bag holding elements 120A-F extending from corners of the top portion 118 of the center piece 116, and three smaller bag holding elements 120G-I extending from center regions between the corners. The bag holding elements 120 may be of various sizes and shapes for supporting the weight of a shopping bag filled with store items. In some embodiments, the bag holding elements 120 may be removable, for example, removed from the top portion 118 of the center piece 116 and replaced with different the bag holding elements.

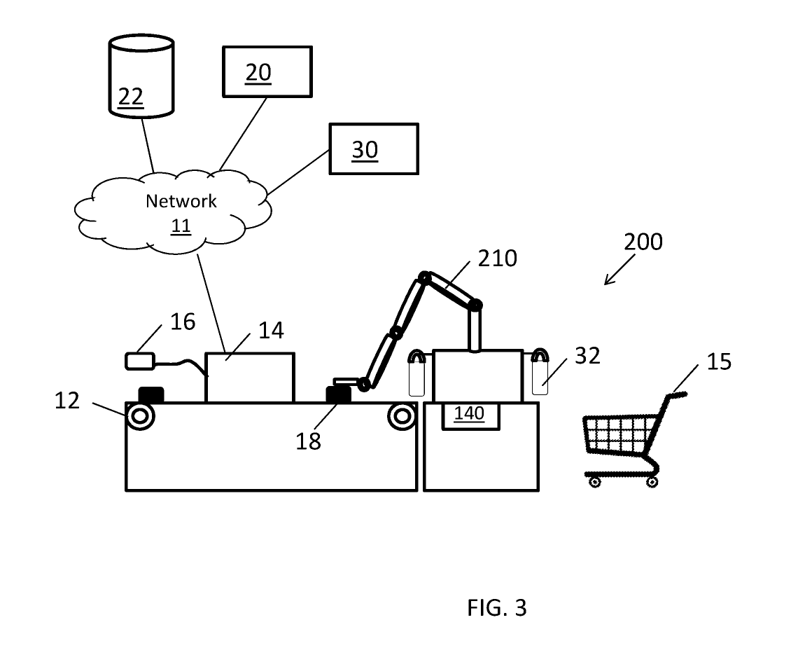

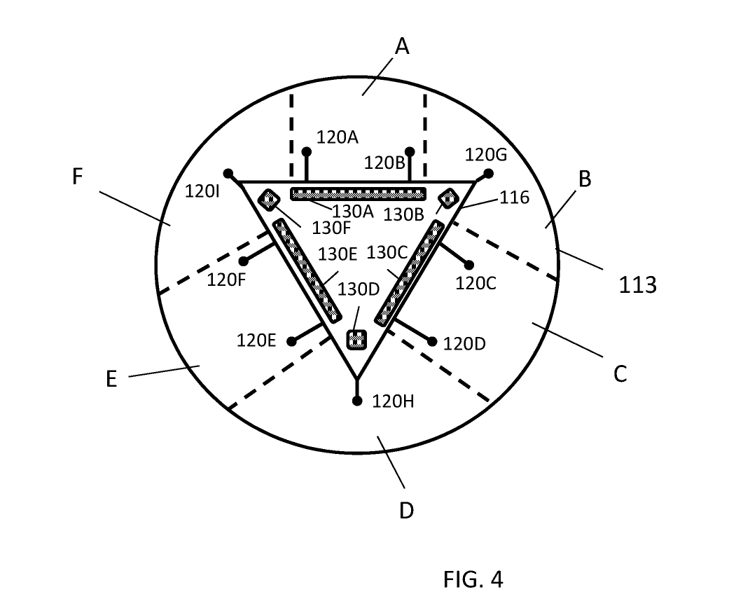

In some embodiments, the bagging station 100 may include at least one indicator, for example, an illuminating element such as a light bar 130A-130C extending along each edge of a top surface 118. The light bars 130A-130C (generally referred to as illuminating elements 130) are constructed and arranged to illuminate in a manner that permits an efficient and acceptable placement of items into an appropriate bag hanging from the bag holding elements 120, for example, aligning with each of the three triangular sides of the center piece 116. As shown and described with respect to FIG. 3, the light bars 130 may illuminate in a manner that is controlled by a bag selection system 20 including special-purpose computer processor that executes computer processes corresponding to one or more different algorithms. Similarly, the bagging station 100 may automatically rotate in a manner that aligns a designated bag for specific item placements according to an algorithm, for example, rotate by a motor (not shown) positioned at a region of the station 100 below a region at which the carousel top rotates. For example, light bar 130C may illuminate to indicate that a bag hanging from a hook of holding element 120H is available for receiving items in response to control signals generated due to the bag selection system 20 determining the rotation of the bagging station 100 so that designated bags are positioned in front of the shopper. In some embodiments, when an item is scanned, the scanner outputs data signals to a store computer 30 (see FIG. 3) in a well-known manner, for example, as part of a POS process. The data signals may also be used by the bag selection system 20 to determine information about the item, which may be used to compare against other items and/or other purposes used to establish which bag on the carousel to be presented in response to the rotation. In addition, a light bar 130 corresponding to a selected bag, for example, a bag on a hook of a holding element 120, may be illuminated by an illuminating element 130 to visually direct the user's attention to the bag identified for inserting the item. In some embodiments, each holding element 120 may have a corresponding LED that produces a particular color depending on the state of a bag hanging on the holding element 120. In other embodiments, a light bar 130A-130C may correspond to a row or other arrangement of multiple holding elements, e.g., hangers, for example, extending along one edge of a triangular carousel as shown in FIG. 4.

In other embodiments, one or more light bars 130 may illuminate to indicate when a bag is occupied at a predetermined amount with items. For example, light bar 130C may illuminate to indicate that a bag hanging from a hook of holding element 120H is full. In this example, the light bar 130C may illuminate one color, for example, green, when the bag is empty, and illuminate a different color, for example, red, when the bag hanging from holding element 120H is full or occupied at a predetermined percentage of its known capacity.

In some embodiments, the light bars 130 may illuminate an alarm-identifiable color such as red when incompatible items are placed in a bag. For example, a bag hanging from a bag holding element 120 may currently have a bottle of ammonia in it. The system is aware of this as described in some embodiments herein. A user may attempt to place a bottle of bleach in the same bag. However, a light bar 130 positioned over the bag holding element 120 may illuminate a color, e.g., red, that indicates to the user that the bottle of bleach should not be placed in the same bag. In this example, when the bleach is scanned by a barcode or quick response (QR) code scanner at the checkout counter, the resulting scan data is output to the bag selection system 20, which in turn activates the light bar 130 due to a rules engine that establishes that the bottle of ammonia was previously scanned and inserted into the bag, which may be further confirmed by electronic sensing elements or the like proximal the bag. An audio alarm may be generated instead of or in addition to the illuminated light bar 130.

As shown in FIG. 4, the bagging station 100 may have a multi-level arrangement, where a plurality of regions are identified for specific product categories. In FIG. 4, the bagging station 100 includes six regions A-F, each having an LED 130A-130F (generally, 130), respectively, and each further including at least one bag holding elements 120. For example, bag holding element 120A may be identified for hanging a bag allocated for holding fresh meat. As described herein, some embodiments include particular bags on particular holding elements 120 matched with specific predetermined items.

The arrangement shown in FIG. 4 is different than that of FIG. 1. For example, a light bar 130A in region A may be associated with bag holding element 120A, which illuminates a color red, which informs a viewer that the bag holding element 120A is for red meat. Similarly, bag holding element 120G in region B may be identified for hanging a bag allocated for holding fragile or breakable items. A light bar 130B may be associated with bag holding element 120E, which illuminates a color blue, which informs a viewer that the bag holding element 120E is for fragile or breakable items. Thus, the lights and colors may be understood to guide a bagging location, i.e., direct a user to the specific light, or more specifically, a bag at a region A-F of the station 100 corresponding to the specific light 120A-F.

In some embodiments, the bagging station 100 includes a plurality of various sensors for identifying items for placement into specific bags and/or other functions. Sensor examples may include but not limited to acoustic, sound, vibration, chemical, moisture, humidity, position, angle, displacement, distance, speed, acceleration, optical, light, imaging, photon, pressure, force, haptic, density, thermal, heat, temperature, radiation, proximity, presence, or a combination thereof., and/or other sensor types known to those of ordinary skill in the art. The sensors may output sensor information to the bag selection system 20, which in turn can compare the sensor information to other data, for example, historical data, stored at a database 22.

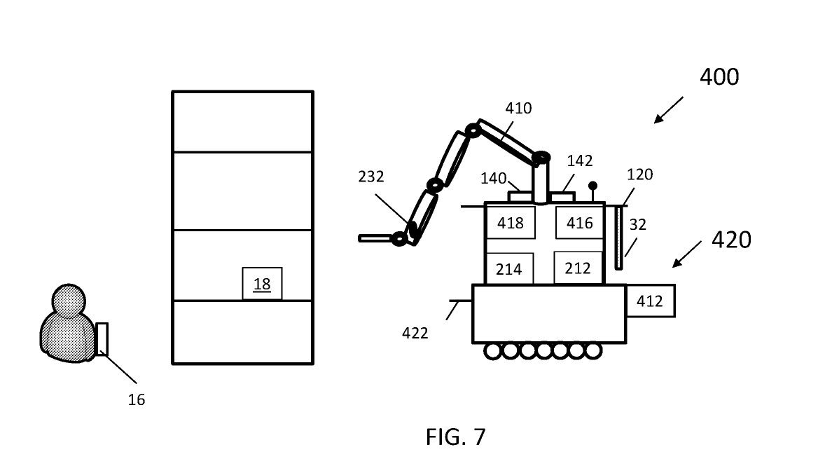

For example, the bag holding elements 120 may include one or more weight sensors 141 that determine an actual weight of a bag 32 and its contents. Although weight sensors 141 are described, other sensors may equally apply, such as chemical detectors and so on. In some embodiments, the bagging station 100 is constructed and arranged to communicate with a self-checkout register scale platform of a checkout counter 10, for example, shown in FIG. 3, which may include a scale platform. In some embodiments, for example, shown in FIG. 7, a checkout register is integrated with a bagging station 400, and can be transported with the bagging station 400 to various locations.

The database 22 may store known information about the bags 32 hanging from the bag holding elements 120, such as weight capacity, bag interior dimensions, and so on. When a store item is placed into a bag, the weight sensor 141 at the bag holding element 120 can determine a current weight of the bag and the item, as well as other items in the bag 32. This weight data may be output to the bag selection system 20 which compares the weight data to a maximum weight capacity of the bag 32. The bag selection system 20 may be in electrical communication with a processor 142 of the scale platform or weight sensors 141 to store the standard weight of each grocery item, which may be predetermined, or by another scale as part of the checkout process, for example, during the scanning and payment portions of a scanning process. The bag selection system 20 in turn may activate a light bar 130, whereby the light bar 130 illuminates a red color, if the comparison result reveals that the bag is near or at its known weight capacity. In addition, or alternatively, the carousel 113 may automatically rotate so that the bag at or near its weight capacity is directed away from the user so that the user cannot insert the item into the bag. In some embodiments, the bagging station 100 includes an audio speaker that outputs an audible alarm in addition to/or in instead of a visual alarm as provided by the light bar 130.

In other embodiments, instead of or in addition to weight sensors used to determine an actual weight, weight data may be determined in response to a barcode, QR code, or other scan of each item to be placed into a bag. The scan data may identify the item and used to retrieve known or historical weight data on the item, which may be stored at the database 22 and used to generate the comparison result. For example, some items such as eggs may be fragile, and not recommended for bagging, and therefore not accessible to a weight sensor at the bagging station 100. In response to barcode, QR code, or the like of a carton of eggs being scanned, the scanner 16 shown in FIG. 3 may output the scan result to the bag selection system 20, which in turn determines the identity of the eggs and automatically sends instruction to the bagging station 100 to illuminate at the light bars 130 an alarm-related color such as red, providing a visual indicator to the customer, store clerk, or other user to not place the eggs into a bag at the bagging station 100.

In another example, the bagging station 100 may include one or more sensors at or near the bags hanging from the bag holding elements 120 to detect specific chemicals, odors, reactions, and so on, and to store this data at the database 22 and/or compare this data to information about other items stored in the bags at the station 100. For example, fresh meat or produce may produce emissions that are detected and used to identify the meat or produce. This data may be used to compare against other items to determine whether they are compatible with those items for placing in the same bags. Similarly, this data can be retrieved by stored data in response to a scan instead of a sensor.

In another example, the bagging station 100 may be used to bag cold chain goods and/or other perishable items. In doing so, referring to FIG. 4, each region in the multi-level arrangement may be allocated for items falling under a particular temperature window. For example, ice cream or other frozen products may be allocated for bags hanging under light bar 130A, while heated items such as pizza, chicken wings, and so on, are allocated for bags hanging under light bar 130B. When a user attempts to place a carton of frozen vegetables into a bag allocated for heated items, the light bar 130B may illuminate red, warning the customer of the incompatibility. The light bar 130B may illuminate due to temperature sensors at or near the bags, or in response to an item scan, where the item is identified.

In another example, the bagging station 100 may include one or more moisture sensors for sensing water content, vapor emissions, or the like of items for bagging, which can be sent to the bag selection system 20 to compare against items previously bagged and to activate a light bar 130 as an alarm to warn the user not to add the item having a predetermined amount of water content, moisture or the like to a bag containing dry goods.

The foregoing examples include the generation of visual, audible, and/or tactile alarms to identify which bag on the bagging station 100 to insert a particular item, and to warn a user and/or mechanical apparatus when it is not appropriate to insert an item into a bag. In other embodiments, one or more sensors are present for detecting when an item has been indeed placed in a wrong bag.

The foregoing examples describe various sensors that collect current and actual conditions or features of an item of interest, e.g., weight, moisture content, and so on. In addition, the database 22 may store item files that include collected attribute information regarding the items, including but not limited to weight, cold chain, crush factors, pantry or refrigerator storage in home, chemical cross-examination, chemical compatibility, bag capacity, or a combination thereof. For example, an attribute may include chemical composition information to ensure that food items are not placed in the same bag as other chemically incompatible items, such as bleach. In this example, a weight sensor may also be used to determine not to place a large bottle of bleach on top of a small fragile box of dryer sheets, which is prone to damage if crushed by larger items. Item attribute data may be used to determine the most appropriate way to stack items without crushing them. Other item attributes such as weight, product features, and bag capacity may be used to determine the manner in which to move the shopping bags.

In some embodiments, items may be identified for exclusion from being bagged. For example, item file attributes may determine items that cannot be bagged due weight limits, size limits, volume limits, and so on.

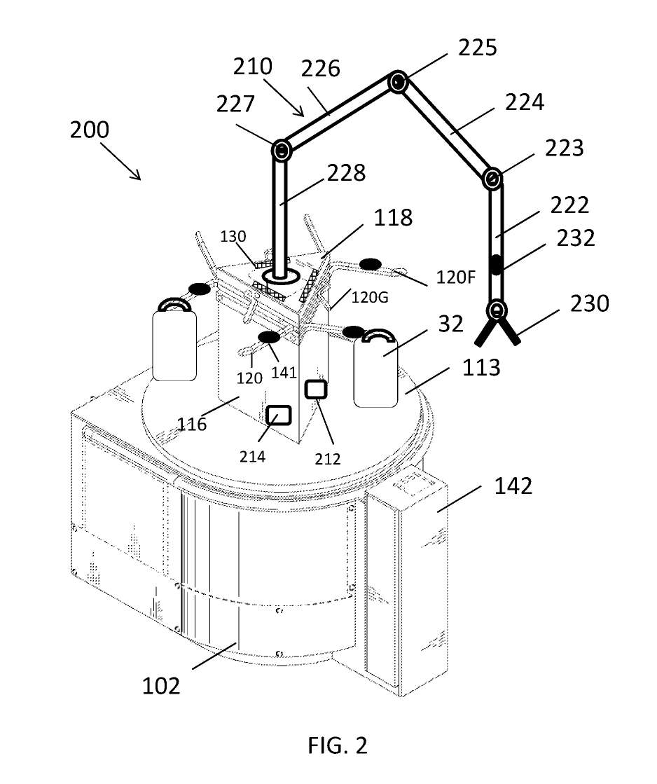

FIG. 2 is a perspective view of a bagging carousel 200 including a robotic arm 210, in accordance with some embodiments. The robotic arm 210 may be included in environments where human cashiers are unavailable and/or where a store automates a checkout and/or customer assistance.

The bagging carousel 200 includes base 102, rotatable carousel top 113, a center piece 116, bag holding elements 120, LED indicator light strips 130, and/or other components that are the same as or similar to those described above with reference to the bagging carousel 100 of FIG. 1. Details thereof are not repeated for brevity.

The robotic arm 210 includes a motion generating control system 212 and a special-purpose computer processor 214 for controlling an articulation of robotic arm 210 with at least one, and preferably multiple, degrees of freedom, for example, up to six degrees of freedom, i.e. a possibility to move in six different planes, for example motion forwards, backwards, upwards, downwards, rotation to the left and rotation to the right, but not limited thereto. A degree of freedom can include but not be limited to articulation in a single plane, rotation about an axis, linear translation along an axis, and combinations of these. The special-purpose computer processor 214 may be part of the carousel control processor 142 that in some embodiments automatically controls the operation of the carousel rotation mechanical components 140 (see FIG. 3).

To provide such motion, an articulating portion of the robotic arm 210 includes several elongated elements 222, 224, 226, 228, and joints 223, 225, 227 therebetween, but not limited thereto, which support a load and a tool, such as an end effector 230, e.g., a grasper, a claw, or the like In addition, the robotic arm 210 may include pneumatic or hydraulic cylinders, electric motors, linkages, wiring, and/or other components known in the field of robotics, in order to operate the robotic arm 210, i.e., to perform include pivotal, rotational, lateral, and/or other movements according to one or more degrees of freedom.

The robotic arm 210 is primarily constructed and arranged to transfer bags 32 into which store items 18 have been inserted, either by a customer, store associate, or other person or by a machine, to a desired location such as a shopping cart, a vehicle trunk or interior seat, a store shelf, or other predetermined location. In some embodiments, the robotic arm 210 is part of the machine used to transfer items 18 from the checkout counter 10 or other surface within reach of the end effector 230 to a predetermined bag hanging from a bag holding element 120 in a manner that maintains a distance between the item and other items determined by the system to be incompatible with the transferred item.

In some embodiments, the robotic arm 210 may include at least one sensor 232, for example but not limited to a sensor for detecting acoustic, sound, vibration, chemical, moisture, humidity, position, angle, displacement, distance, speed, acceleration, optical, light, imaging, photon, pressure, force, haptic, density, thermal, heat, temperature, radiation, proximity, presence, or a combination thereof., and/or other sensor types known to those of ordinary skill in the art. A sensor 232 may perform detection functions similar to or the same as sensors 141 shown and described in FIG. 1. The sensors 232 may output sensor information to the bag selection system 20, which in turn can compare the sensor information to other data, for example, historical data, stored at a database 22. For example, a sensor 232 on the robotic arm 210 can sense the surroundings, for example, when carrying bleach it senses the presence of ammonia. In response, the arm 210 doesn't move the bleach near the ammonia. In this example, the arm 210 may receive instructions from the bag selection system 20 to place an item from a conveyor 12 into a particular bag, but may automatically cease its articulation when the sensor 232 detects that the item is bleach and the identified bag includes ammonia, which may have been inadvertently inserted into the bag by a user independently of the system.

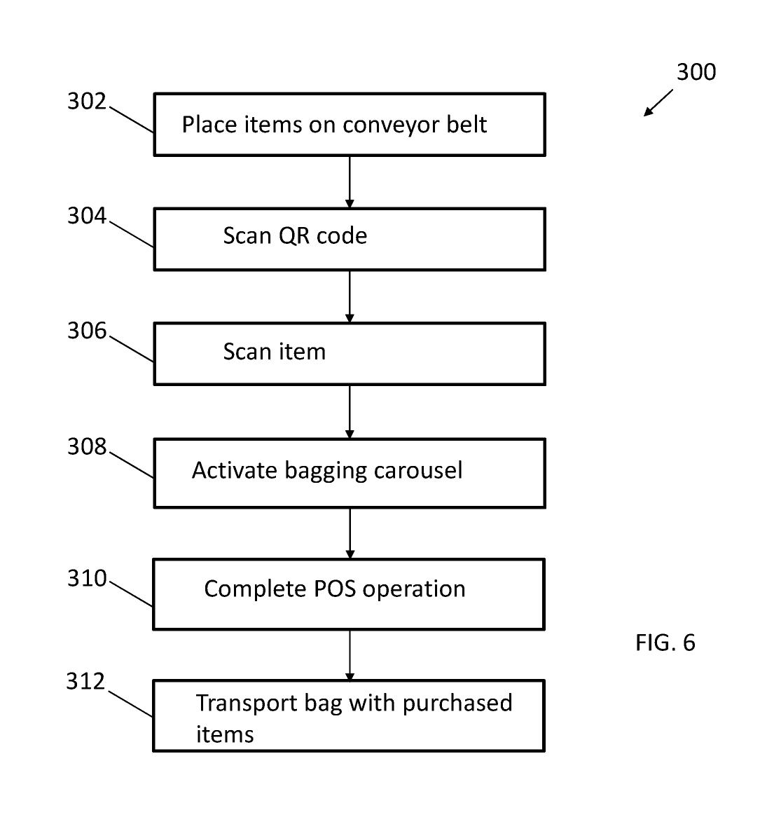

FIG. 6 is a flow diagram of a method 300 of operating a bagging carousel, in accordance with some embodiments. In describing the method 300, reference is made to elements of FIGS. 1-3. Some or all of the method 300 can be performed by a bagging station, system, or environment described in an embodiment herein, or more specifically, executed by a special-purpose computer or subroutine of a bagging station, system, or environment programmed to perform the method 300.

At block 302, a customer or machine places store items 18 for purchase at a POS location, for example, a checkout counter 10 having a conveyor belt 12 and a POS computer 14 as shown in FIG. 3.

At block 304, a QR code is scanned by a scanning device 16. A software application may be executed by a personal computer, such as a smartphone to set bagging preferences, perform scanning functions, and so on. As described in some embodiments, item attributes are provided to set standards. Here, in one example, a customer may store flower in a kitchen spice cabinet rather than a pantry. The customer may configured bagging preferences from a personal computer to specify that bag of flour may be loaded into a same bag as spices to make unloading easier at home. When the customer reaches the register, a QR code generated on their phone via the Walmart app is scanned at the register to communicate to the bagging system the preferences stored for the customer. In some embodiments, the QR code is generated by the customer's smartphone or the like, including the codified bagging preferences. The customer may launch the software application and the generated QR code and then scan the QR code on the bagging system.

Block 306, the store item 18 is scanned, for example, using a scanning device that scans barcodes, QR codes, universal product codes (UPC), or other identifier on the store item 18 that provides information about the item 18 to be purchased. The scan operation is different than the scan operation of block 304 in which a QR code or the like is generated that includes bagging preference information. A store associate may scan the item using the scanning device 16. Alternatively, at a self-checkout counter, the shopper may scan the item using a store-provided scanner, or using the customer's personal smartphone or other mobile device which is executed using a store application. Item information from the scan operation may be retrieved and output to the bag selection system 20 and/or other store computer 30, where information about the item may be retrieved from the database 22. This data may be used to determine which bag 32 to be used for the store item 18. In preferred embodiments, a single scan is required, for example, a single QR code scan is required to load the preferences with respect to a bagging compliance and so on.

In some embodiments, the bags 32 may be of different colors, sizes, and/or shapes to distinguish the bags from each other, and to identify certain bags 32 with specific items. For example, bags that are colored red, or marked with a hazardous material symbol may be allocated for items containing dangerous chemicals. When the carousel 113 is constructed and arranged for manual rotation, the user can be easily distinguish the bags for specific use. In another example, certain bags may include plastic liners for thermal protection for use only with frozen foods such as ice cream.

At block 308, the bagging carousel 100 is activated. In doing so, one or more light bars 130 on the bagging carousel may illuminate to indicate which bag 32 will be used for inserting the scanned item. In some embodiments, the carousel top 113 automatically rotates, i.e., in response to an output of the carousel control processor 142 and carousel rotation mechanical components 140 to position the bag 32 so that the shopper (FIG. 1) or robotic arm 210 (FIGS. 2 and 3) can place the item into the selected bag 32. For example, the carousel top 113 may automatically rotate a selected bag 32 into position based on the item scan result generated in block 306. In some embodiments, the carousel top 113 rotates in response to a scan operation performed on the item, and based on the scan result and stored item attributes and preferences so that the most appropriate bag is presented to the customer or robot arm for placement of the item. In other embodiments the carousel top 113 is manually moved, i.e., by a user rotating the carousel top 113 until the identified bag 32 is in a favorable position for inserting the item corresponding to the illuminated light bar 130. The bag 32 may be selected according to the algorithms executed at the bag selection system 20.

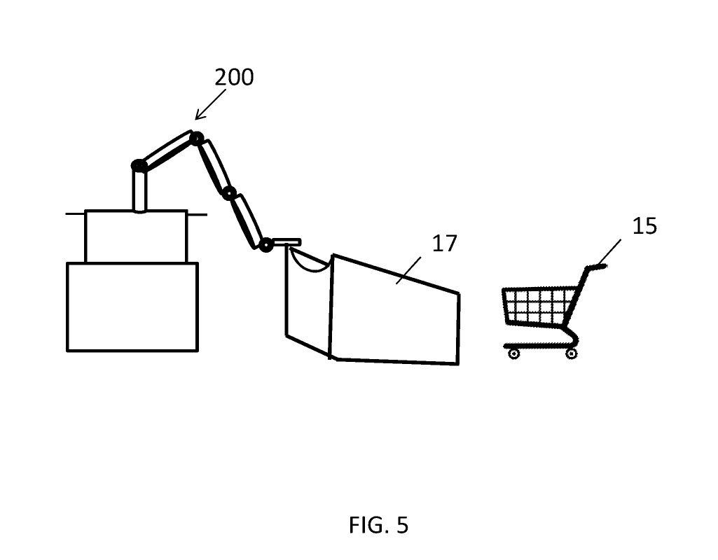

As items 18 are scanned and bagged, bags 32 are moved by the shopper, store associate, robotic arm 210 and/or other automated machine from the carousel to a shopping cart 15 and/or other location, for example, via a chute 17 shown in FIG. 5, which may operate in connection with bagging apparatus 200 as shown, or with bagging apparatus 100 of FIG. 1 or bagging apparatus 400 of FIG. 6, but not limited thereto

At block 310, the POS operation is completed where the items 18 are purchased, i.e., payment is made in a well-known manner by processing a credit or debit card, receiving cash from the customer, and so on.

At block 312, the bag with the items placed therein is transported to another location. In some embodiments, the purchaser or store associate may use the shopping cart 15 or a basket or other carrying apparatus to manually carry the purchased items to a vehicle or other location. In other embodiments, the bags 32 are automatically transported to a different loading location using automation mechanisms such as a robotic apparatus, unmanned autonomous vehicle, and so on.

In other embodiments, a method that includes at least some of the steps of method 300 may be implemented to operate the bagging carousel having have a multi-level arrangement, where a plurality of regions are identified for specific product categories shown in FIG. 4.

Here, a linked item file on attributes is stored at the database 22. An item file includes many item attributes which can be used, for example, attributes regarding chemical composition to ensure food items are not placed in the same bag as bleach.

A combination of illuminated lights output as different colors may be used to identify the bag, or bagging holder, to insert items received from a conveyor belt 12 at a checkout counter 10 or other checkout counter location, or during a shopping trip at a particular store location prior to checkout, for example, where the carousel 100 is available to retrieve items from store shelves, produce areas, and so on and place them into bags.

In these other embodiments, the carousel 100 automatically rotates so that a bag identified for a particular item is aligned with the illuminated light. For example, a bag 32 may be determined by weight sensors or the like to be at 50% of its capacity. Scan data regarding an item may reveal that the item is of a sufficient weight and dimension for insertion into the identified bag 32. The carousel top 113 may automatically rotate in response to the bag selection system 20 establishing that a comparison between the item scan data and current weight of the bag 32 permits the bag 32 to receive the item. The light bar 130 corresponding to the identified bag 32 may illuminate a color, such as green, when the bag 32 is determined to be available for receiving additional items, and may change to red when the bag 32 is at capacity. When the bag 32 is determined to be full, the bag 32 may be removed from the respective holding element 120 and positioned on a chute 17 shown in FIG. 5, where the bag 32 may slide down the chute 15 and into a shopping cart 15 or other apparatus for transport by the customer to a different location. Therefore, the foregoing method may be completely automatic whereby no human intervention is required from the POS location to the bagging station 100 to the transport vehicle, e.g., shopping cart 15 for leaving the store.

Referring to FIG. 7, an autonomous bagging apparatus 400 includes a robotic arm 410 constructed and arranged to perform multiple point of sale operations, in accordance with some embodiments. The robotic arm 410 may be similar to or the same as the robotic arm 210 of FIG. 3. Details thereof are not repeated due to brevity. The autonomous bagging apparatus 400 may include elements similar to rotatable carousel top 113, center piece 116, and plurality of bag holding elements 120A-120F, and/or other elements of the bagging carousel 100 and/or 200. Details thereof are not repeated due to brevity. The autonomous bagging apparatus 400 may be part of a delivery vehicle 420, such as a manned vehicle or an autonomous ground vehicle (AGV), drone, or the like. Details of such delivery vehicles are well-known, and not repeated herein for brevity. In some embodiments, the robotic arm is constructed and arranged to Robot retrieve products from a store shelf or other location in response to the customer scanning a barcode of the product, for example, in applications where the customer has a mobile device configured to scan and process items of interest. In some embodiments, the customer is not required to physically identify a store item to initiate the bagging process. Instead, in applications where the customer has a mobile device configured to scan and process store items, the autonomous bagging apparatus 400 may initiate a process in response to the customer scanning an item of interest for an immediate checkout, which may occur at a different location than a checkout counter. The delivery vehicle 420 including the autonomous bagging apparatus 400 may include a drop platform 422 or the like that allows the customer to place an item of interest on the delivery vehicle 420. The autonomous bagging apparatus 400 in turn may perform a bagging operation with respect to the item placed on the platform 422. In some embodiments, the delivery vehicle 420 may include a storage location instead of or in addition to a drop platform 422, such as a container or the like for carrying items during transport.

The robotic arm 410 may include one or more sensors 232 that perform detection functions similar to or the same as sensors 141 shown and described in FIG. 1. The autonomous bagging apparatus 400 includes a location detection device 418 that can track a shopper, for example, by communicating with the shopper's smartphone 16 or other mobile device, and thereby follow the shopper's movements via the smartphone 16. The location detection device 418 may be collocated with the sensors 232 on the robotic arm 410, or located elsewhere on the bagging apparatus 400. When following the shopper, the autonomous bagging apparatus 400 can perform one or more functions to assist the shopper with purchasing items during a shopping trip such as, but not limited to scanning, checkout, payment, and bagging functions. To perform such functions, in some embodiments, the autonomous bagging apparatus 400 includes a scanning device 412 such as a barcode or QR code scanning device, a POS processing device 414 such as a checkout register or the like, and a communication device 416. In some embodiments, the autonomous bagging apparatus 400 includes a base comprising carousel rotation mechanical components 140 and a carousel control processor 142 similar to that described in FIG. 1, for automatically controls the rotation of the robotic arm 410 from the carousel platform.

The communication device 146 may include an antenna and/or other mobile network components so that electronic signals may exchange data between the autonomous bagging apparatus 400 and other computer devices, such as the shopper's smartphone 16 or other personal computing device, the bag selection system 20, and/or other store computer 30 via a network 11. For example, during an operation, the autonomous bagging apparatus 400 performs some or all of the method 300 of FIG. 6 by communicating with the bag selection system 20 to rotate the bagging apparatus in a manner that aligns a designated bag for specific item placements according to algorithms executed by the bag selection system 20, and/or communicating with the store computer 30 to process data retrieved by the scanner 412 and POS processing device 414.

In some embodiments, the bag selection system 20 includes a loading map that includes details on a shopping cart loading arrangement. Here, the robotic arm 410 is programmed to place shopping bags filled with store items into a shopping cart or the like according to predetermined criteria. For example, using sensors 232 and/or predetermined bagging criteria, a determination made by made that a particular bag includes a carton of eggs. The loading map can establish that any bag including eggs is to be loaded last, and positioned on top of a heavy bag, to ensure that the bag including eggs is not crushed by heavier bags.

A computer program product of the present inventive concepts comprises one or more computer readable hardware storage devices having computer readable program code stored therein, said program code containing instructions executable by one or more processors of a computer system to implement the methods of the present inventive concepts.

A computer program product of the present inventive concepts comprises one or more computer readable hardware storage devices having computer readable program code stored therein, said program code containing instructions executable by one or more processors of a computer system to implement the methods of the present inventive concepts.

A computer system of the present inventive concepts comprises one or more processors, one or more memories, and one or more computer readable hardware storage devices, said one or more hardware storage devices containing program code executable by the one or more processors via the one or more memories to implement the methods of the present inventive concepts.

The present inventive concepts may be a system, a method, and/or a computer program product at any possible technical detail level of integration. The computer program product may include a computer readable storage medium (or media) having computer readable program instructions thereon for causing a processor to carry out aspects of the present inventive concepts.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present inventive concepts may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present inventive concepts.

Aspects of the present inventive concepts are described herein with reference to flowchart illustrations and/or block diagrams of methods, apparatus (systems), and computer program products according to embodiments of the inventive concepts. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present inventive concepts. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present inventive concepts have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A bagging station, comprising:
a base;
a carousel that rotates relative to the base, the carousel including a plurality of bag holding elements;
an indicator at each bag holding element that provides a status regarding a bag hanging from the bag holding element;
a bag selection system that controls the indicators to identify bags for allocating items according to a predetermined criteria about at least one of the bag or the items;
a robotic arm extending from the carousel and having an end effector for gripping the bags for at least one of automatically placing the allocated items into the identified bags or moving the bags including the allocated items from the carousel to a different location; and
a controller that directs the robotic arm to at least one of insert the items into the identified bags according to the predetermined criteria or move the bags including the allocated items from the carousel to the different location.

2. The bagging station of claim 1, wherein the carousel automatically rotates to a predetermined position in response to the bag selection system identifying a bag of the identified bags for allocating an item according to the predetermined criteria.

3. The bagging station of claim 1, wherein the bag selection system processes stored item files that include collected attribute information regarding at least one of the items or the bags, wherein the predetermined criteria includes the attribute information.

4. The bagging station of claim 3, wherein the attribute information includes data regarding at least one of weight, cold chain, crushability, temperature-related storage, chemical compatibility, or bag capacity, bag weight or volume, or size, item fragility or crush-related data, or a combination thereof.

5. The bagging station of claim 3, wherein the bag selection system includes a rules engine that establishes the predetermined criteria according to the attribute information.

6. The bagging station of claim 3, wherein the bag selection system processes item attributes of the attribution information, including at least one of weight, product features, and bag capacity to determine a manner in which to move the bags on the carousel.

7. The bagging station of claim 1, further including at least one sensor for determining a placement of the identified items into specific bags at the bag holding elements.

8. The bagging station of claim 1, wherein the carousel is constructed and arranged into a plurality of regions, each region arranged for holding a bag designated for a particular type of item.

9. The bagging station of claim 1, wherein the bags are of different colors, for further distinguishing the bags from each other and identifying the bags for allocating the items.

10. A bagging station, comprising:
a base;
a carousel that rotates relative to the base, the carousel including a plurality of bag holding elements;
a robotic arm extending from the carousel and having an end effector for at least one of automatically placing items into bags on the bag holding elements or removing the items from the bags from the bag holding elements;
a visual indicator at each bag holding element that provides a status regarding the bag hanging from the bag holding element; and
a controller that directs the robotic arm to move the items or bags according to predetermined criteria.

11. The bagging station of claim 10, further comprising a bag selection system that controls the indicators to identify bags for allocating items according to the predetermined criteria, and further communicates with the controller to articulate the robotic arm according to the predetermined criteria.

12. The bagging station of claim 11, wherein the bag selection system comprises a loading map, and the predetermined criteria includes a loading arrangement establishing the placement of the bags into which the items are placed into a shopping cart.

13. The bagging station of claim 11, wherein the bag selection system processes stored item files that include collected attribute information regarding at least one of the items or the bags, wherein the predetermined criteria includes the attribute information.

14. The bagging station of claim 13, wherein the bag selection system processes item attributes of the attribution information, including at least one of weight, product features, and bag capacity to determine a manner in which to move the bags on the carousel.

15. The bagging station of claim 10, wherein the carousel automatically rotates the robotic arm to a predetermined position for the items or bags according to the predetermined criteria.

16. The bagging station of claim 10, further including at least one sensor for determining a placement of the identified items into specific bags at the bag holding elements.

17. The bagging station of claim 10, wherein the carousel is constructed and arranged into a plurality of regions, each region arranged for holding a bag designated for a particular type of item.

18. A machine-readable storage medium having stored thereon a computer program for selecting a bag at a bagging station, the computer program comprising a set of programmable instructions for causing the machine to perform the steps of:
receiving machine-readable bagging preference data;
receiving machine-readable item data; and
controlling a bagging carousel to identify a shopping bag from a plurality of bags for receiving an item of merchandise corresponding to the machine-readable item data.

19. The machine-readable storage medium of claim 18, further receiving a processing item attributes of a linked item file to identify the shopping bag for receiving the item.
